(19) United States
(12) Patent Application Publication
(10) Pub. No.: US 2026/0167275 A1
(43) Pub. Date: Jun. 18, 2026

(54) METHOD OF MANUFACTURING AND ASSEMBLING LOW-PROFILE DOOR FRAME CORNER POSTS

(71) Applicant: Strick Trailers, LLC, Monroe, IN (US)

(72) Inventors: Kevin Seitz, Decatur, IN (US); Bradley W. Pontius, Rockford, OH (US); Andrew J. Gabet, New Haven, IN (US)

(73) Assignee: Strick Trailers, LLC, Monroe, IN (US)

(21) Appl. No.: 18/984,193

(22) Filed: Dec. 17, 2024

(51) Int. Cl. B62D 33/04

(52) U.S. Cl. CPC B62D 33/04

(57) ABSTRACT

A trailer corner post can comprise an exterior panel, a U-shaped intermediate panel, an S-shaped extension panel, and a U-shaped interior panel. The U-shaped intermediate panel includes a first planar middle section and first and second leg sections extending from opposite ends thereof. The S-shaped extension panel includes a first S-shaped middle section and first and second planar end sections extending from opposite ends thereof. The U-shaped interior panel includes a second planar middle section and third and fourth leg sections extending from opposite ends thereof. The corner post can be manufactured by securing the first and second leg sections to the exterior panel, securing the first planar end section to the first or second leg section and/or the exterior panel, securing the third leg section to the exterior panel, and securing the fourth leg section to the first planar end section and/or the exterior panel.

### BACKGROUND OF THE INVENTION

### 1. Field of the Invention

The present invention relates to door frames for ground transportation vehicles such as semi-trailers. More particularly, the present invention is directed to a method of manufacturing and assembling a low-profile corner post for the door frame of a semi-trailer.

### 2. Background

Enclosed ground transportation vehicles, such as, for example, semi-trailers, box trailers, and box trucks, are one of the most commonly used methods for transporting goods (commonly referred to as “cargo” or “freight”) including, for example, goods stored on pallets and oversized goods such as, for example, equipment and building materials. An enclosed ground transportation vehicle, such as an enclosed semi-trailer, typically includes a frame having axles mounted thereto and wheels rotatably mounted on the axles, a floor platform supported above the frame, side walls extending one on either side of the floor platform, and a roof supported by the side walls vertically above the floor platform. The trailing end of the trailer is enclosed by a pair of doors which are pivotably mounted on and supported by a door frame. The roof, walls, and doors form a barrier around the cargo storage space and protect the cargo stored therein from the wind, rain, debris, etc. and the doors provide access for loading and unloading cargo from the trailer.

The door frame of a semi-trailer includes a horizontal sill member, a pair of vertical corner posts, and a horizontal head member. The horizontal sill member is secured to the frame of the trailer and forms the bottom end of the door frame. The vertical corner posts extend upwardly from opposite ends of the horizontal sill member and are configured to engage hinge plates which are used to pivotably mount the doors to the door frame. The vertical corner posts are also secured to the side walls of the trailer. The horizontal head member extends between the upper ends of the vertical corner posts and is secured to the corner posts and the trailer roof. In addition to supporting the doors, the door frame provides structural support for the side walls and roof to prevent them from collapsing from the dynamic forces experienced during operation of the semi-trailer. Accordingly, the sill member, corner posts, and head member must be sufficiently robust to ensure the door frame is able to resist the forces experienced by the trailer.

In use, the width of the door frame opening (i.e., the distance between the two corner posts) impacts the efficiency of loading and unloading the trailer and the maximum size of goods which can be transported on the trailer. For example, most U.S. states restrict the total width of a semi-trailer to a maximum of 102 ″. Traditional corner posts are generally more than 2 ″ wide. As such, the width of a traditional door frame opening (i.e., the distance between the two corner posts) is typically less than 98″.

As mentioned above, semi-trailers are commonly used for transporting cargo including goods stored on pallets and oversized goods such as equipment and building materials. With respect to palleted goods, pallets are typically constructed in standard sizes with the most common size being 48 ″ long and 40 ″ wide. Goods stored on such pallets are typically packaged to fit within the 48 ″×40 ″ footprint of the pallet, however it is also common for palleted goods to protrude a few inches on either side of the pallet depending on the size, shape, and organization of the goods. When palleted goods are loaded onto a semi-trailer, they are typically organized into two side-by-side rows having a total width of up to 100 ″ or so.

For loading and unloading efficiency purposes, palleted goods are preferably loaded in side-by-side pairs using powered loading equipment, such as, for example, a double pallet forklift, or an automated loading system, such as, for example, an automated conveyor system. However, as should now be appreciated, if the palleted goods protrude on either side of the pallets, the total width of the side-by-side pair of pallets may be greater than width of a traditional door frame opening which would require the pallets to be loaded and unloaded individually; thus, reducing efficiency.

Similarly, oversized goods, such as, for example, equipment and building materials, may have a width greater than 98 ″. Such goods would not fit through a 98 ″ wide traditional door frame opening, and so, would not be transportable using a traditional semi-trailer.

Accordingly, there exists a need for an improved, low-profile corner post which is thin enough such that cargo having a width of up to 100 ″ fits through the door frame opening while simultaneously being robust enough to resist the dynamic forces experienced by the trailer.

### SUMMARY OF THE INVENTION

In one form thereof, the present invention is directed to a method of manufacturing a corner post of a trailer door frame. The corner post comprises an exterior panel, a U-shaped intermediate panel, an S-shaped extension panel, and a U-shaped interior panel. The exterior panel can be configured to couple a door to the door frame. The U-shaped intermediate panel includes a first planar middle section and first and second leg sections. The first and second leg sections extend from opposite ends of the first planar middle section. The S-shaped extension panel includes a first planar end section, a first S-shaped middle section, and a second planar end section. The first and second planar end sections extend from opposite ends of the first S-shaped middle section. The U-shaped interior panel includes a second planar middle section and third and fourth leg sections. The third and fourth leg sections extend from opposite edges of the second planar middle section.

The method of manufacturing the corner post comprises the steps of: (i) securing the first and second leg sections to the planar panel; (ii) securing the first planar end section of the S-shaped panel to one of the first and second leg sections and/or to the exterior panel; (iii) securing the third leg section of the U-shaped interior panel to the exterior panel; and (iv) securing the fourth leg section of the U-shaped interior panel to the first planar end section of the S-shaped panel and/or to the exterior panel. Preferably, the panels are secured together by welding.

Preferably, the first planar end section of the S-shaped panel includes a first vertical edge having a first plurality of notches formed therein. During assembly, the first vertical edge is disposed adjacent to the second leg section of the first U-shaped panel and the first planar end section is welded to the second leg section and the outer panel interior surface along the first vertical edge.

Preferably, the exterior panel includes a second vertical edge having a second plurality of notches formed therein. During assembly, the second vertical edge is disposed adjacent to the first planar end section and the exterior panel is welded to the first planar end section along the second vertical edge.

Preferably, the second planar middle section of the U-shaped interior panel includes a plurality of slots formed therein. During assembly, the second planar middle section is disposed adjacent to the first planar middle section and the second planar middle section is welded to the first planar middle section along an edge of each slot.

Preferably, the first plurality of notches, the second plurality of notches, and the plurality of slots are substantially filled in with a weld filler material during assembly of the corner post.

Preferably, the method further includes the step of manufacturing the exterior panel, U-shaped intermediate panel, S-shaped panel, and U-shaped interior panel by extruding, bending, stamping, or laser cutting from a stock material. Yet more preferably, the method includes the steps of manufacturing the exterior panel and S-shaped panel by cutting and bending from stock sheets of steel and manufacturing the U-shaped intermediate panel and U-shaped interior panel by laser cutting sections from lengths of rectangular steel tubing stock.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1 is a perspective view of the trailing end of a semi-trailer;

FIG. 2 is another perspective view of the trailing end of the semi-trailer wherein a portion of the roof and a side wall have been cut away to show the interior of the trailer;

FIG. 3 is an exploded perspective view of a door frame and a pair of doors;

FIG. 4 is a perspective view of a semi-trailer shown in FIG. 1 wherein the doors are open and the roof has been removed to show the cargo inside of the trailer;

FIG. 5A is a perspective view of the cargo shown in FIG. 4 stored on a pallet;

FIG. 5B is a top plan view of the pallet shown in FIG. 5B;

FIG. 6 is a rear elevation view of the semi-trailer shown in FIG. 4;

FIG. 7A is a rear elevation view of the semi-trailer wherein the doors are closed;

FIG. 7B is a section view taken along the line 7B-7B shown in FIG. 7A;

FIG. 8 is an exploded perspective view a corner post;

FIG. 9 is a perspective view of a corner post wherein the U-shaped interior panel has been removed for greater clarity;

FIG. 10 is a side elevation view of the corner post shown in FIG. 9;

FIG. 11 is another perspective view of a corner post;

FIG. 12 is a side elevation view of the corner post shown in FIG. 11;

FIG. 13 is a perspective view of a corner post including a U-shaped interior panel mounted over the U-shaped intermediate panel; and,

FIG. 14 is a side elevation view of the corner post shown in FIG. 11.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

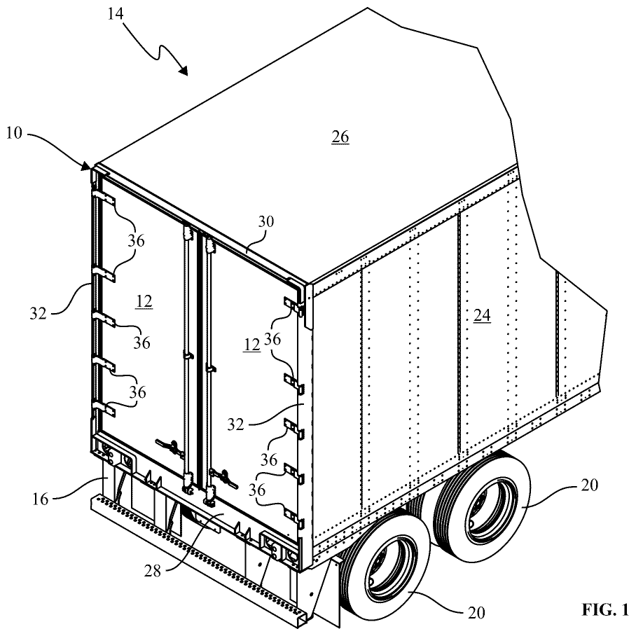

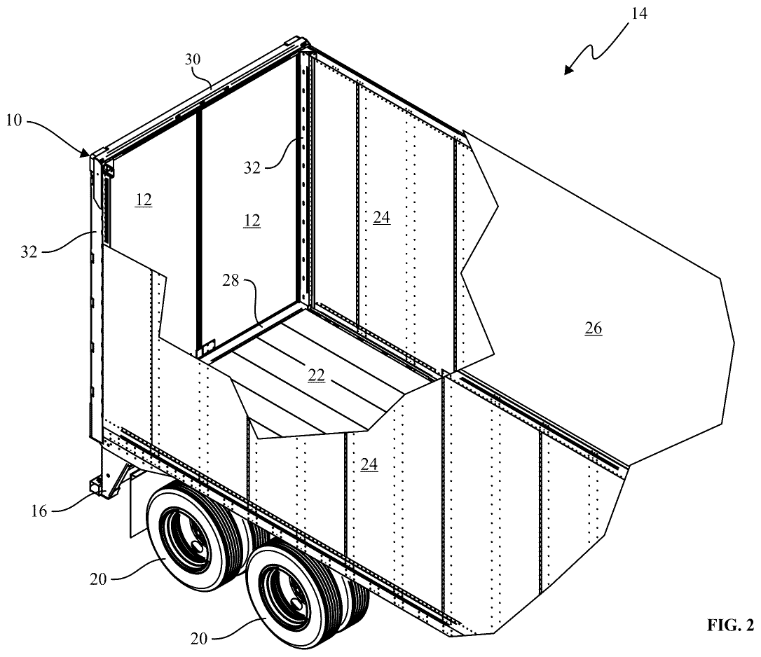

Referring initially to FIGS. 1-7, a door frame constructed in accordance with the principles of the present invention is designated by the numeral 10. The door frame 10 is configured to pivotably couple a pair of doors 12 to a ground transport vehicle, such as, for example an enclosed semi-trailer 14. A semi-trailer 14 typically includes a frame 16 having axles 18 mounted thereto and wheels 20 rotatably mounted on the axles, a floor platform 22 supported on top of the frame 16, side walls 24 extending one on either side of the floor platform 22, and a roof 26 supported by the side walls 24 vertically above the floor platform 22. The trailing end of the semi-trailer 14 is enclosed by a pair of doors 12 which are supported by and pivotably mounted to a door frame 10.

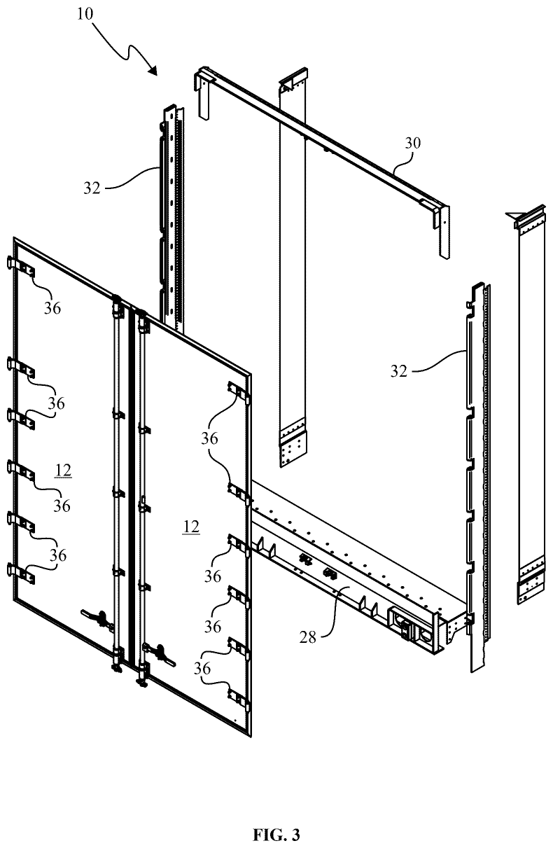

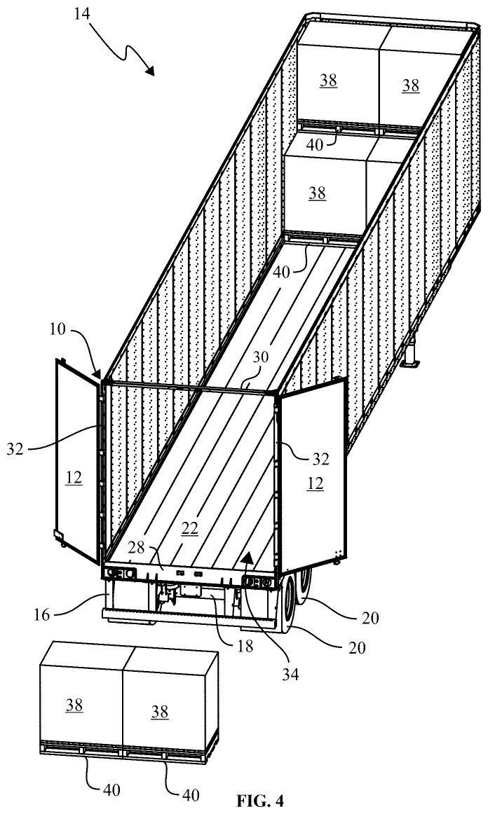

As best seen in FIGS. 3 and 4, the door frame 10 includes a horizontal sill member 28, a horizontal head member 30, and a pair of vertical corner posts 32. The horizontal sill member 28 is mounted to the trailer frame 16 and forms the bottom of the door frame 10. The corner posts 32 extend upwardly one from either end of the horizontal sill member 28 and couple to the trailer side walls 24. The horizontal head member 30 is coupled to and extends between the upper ends of the corner posts 32 vertically above the horizontal sill member 28. A door frame opening 34 is defined between the horizontal sill member 28, the corner posts 32, and the horizontal head member 30. The trailer doors 12 are pivotably coupled to the corner posts 32 by hinge plates 36. In addition to supporting the doors 12, the door frame 10 also provides structural support for the side walls 24 and roof 26 of the semi-trailer 14.

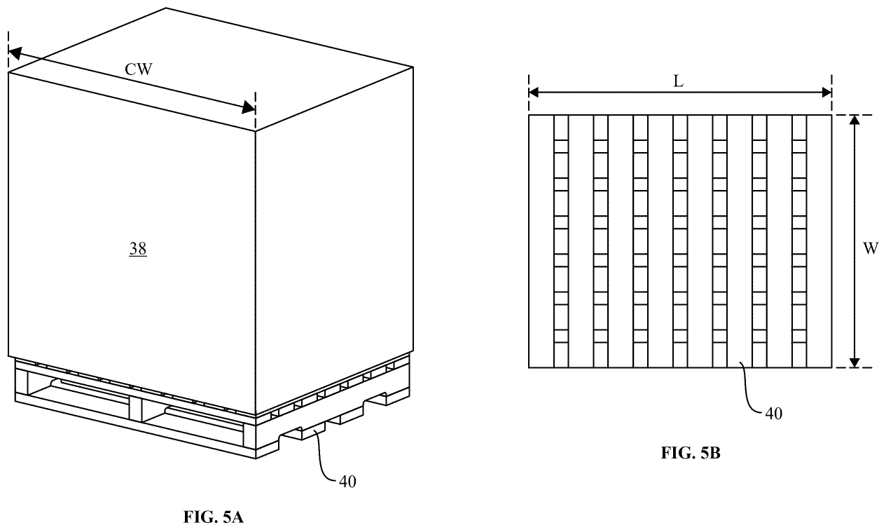

Semi-trailers 14 are commonly used for transporting cargo 38 stored on pallets 40 (FIGS. 4-6) and oversized cargo such as equipment and building materials (not shown). With respect to palleted cargo 38, pallets 40 are typically constructed in standard sizes with the most common size being 48 ″ long (FIG. 5B, dimension line L) and 40 ″ wide (FIG. 5B dimension line W). The cargo 38 stored on such 48 ″×40 ″ pallets may protrude slightly on either side of the pallet 40 whereby the total width of a pallet 40 of cargo 38 (FIG. 5B, dimension line CW) can be approximately 50″.

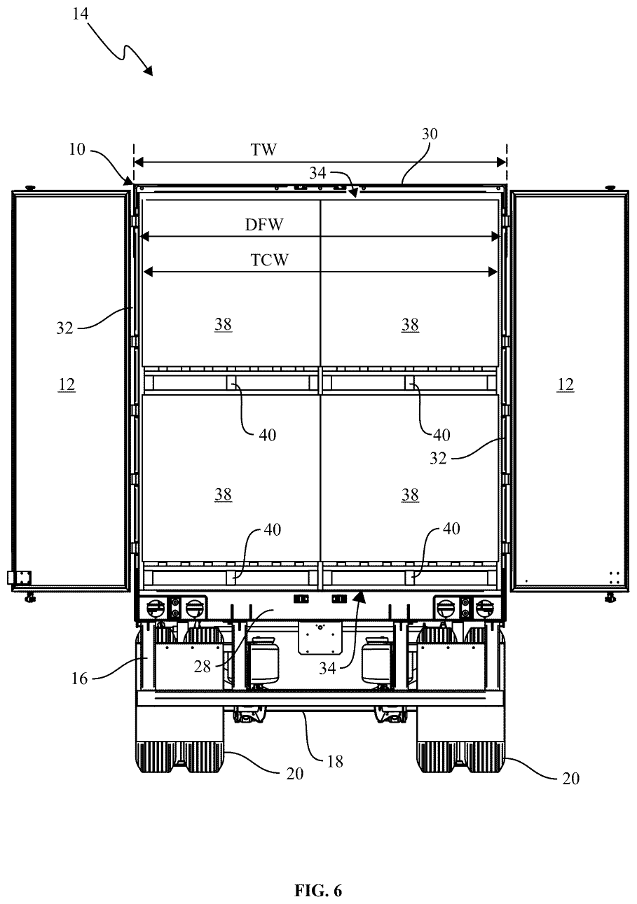

When pallets 40 of cargo 38 are loaded onto a semi-trailer, they are typically organized into two side-by-side rows having total width (FIG. 6, dimension line TCW) of up to 100 ″ or so. This ensures there is a small amount of space between the pallets/cargo 38 and the trailer side walls 24 for maneuvering the pallets/cargo 38 within the trailer 14 while minimizing the amount of empty space within the trailer 14. For loading and unloading efficiency purposes, pallets 40 of cargo 38 are preferably loaded in side-by-side pairs using powered loading equipment, such as, for example, a double pallet forklift, or an automated loading system, such as, for example, an automated conveyor system.

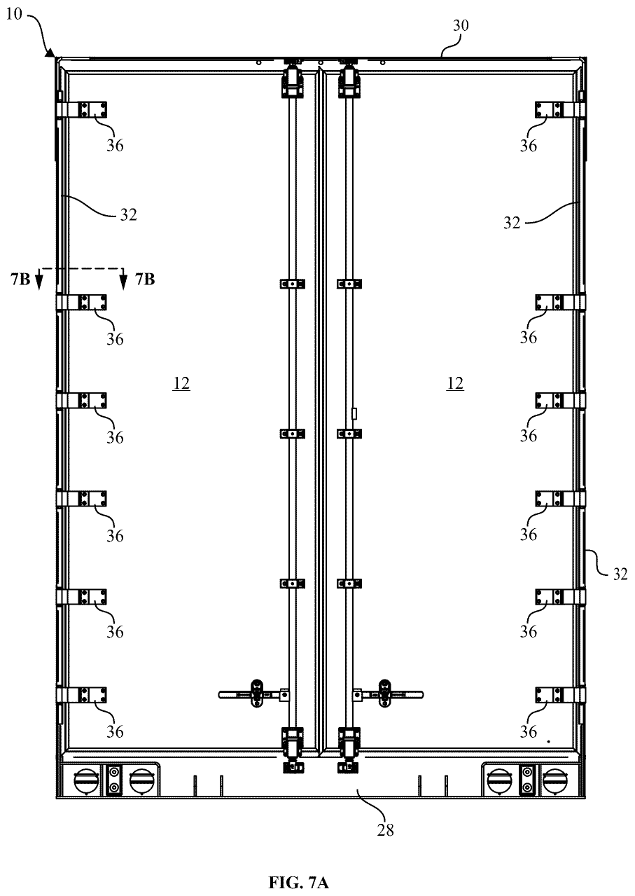

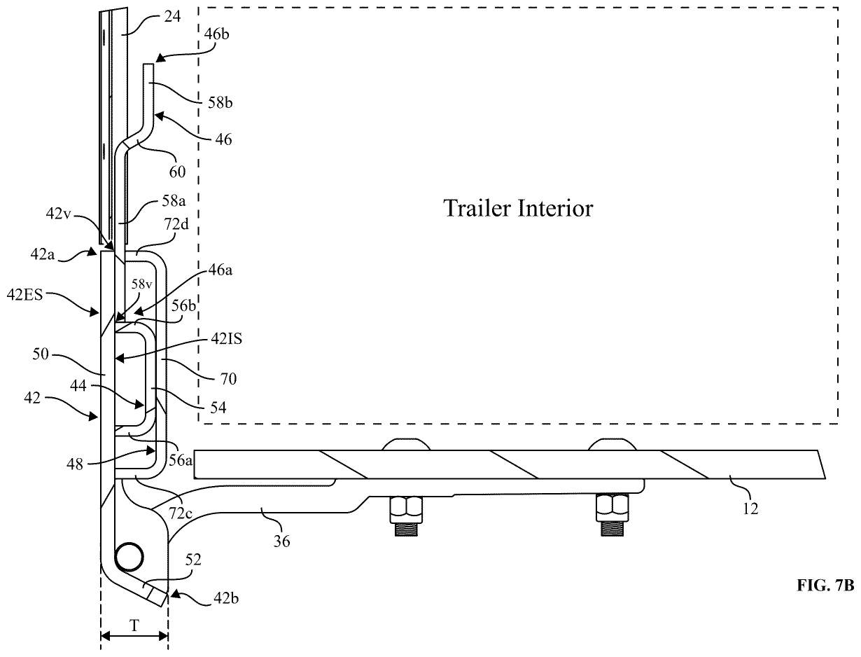

In the present invention, the door frame 10, and, more particularly, the corner posts 32, are configured such that the width of the door frame opening 34 (FIG. 6, dimension line DFW) is approximately 100 ″ whereby two side-by-side pallets 40 of cargo 38 having a total width TCW of up to 100 ″, or oversized cargo having a width of up to 100 ″, can be loaded through the door frame opening 34. In this regard, most U.S. states restrict the total width of a semi-trailer 14 (FIG. 6, dimension line TW) to a maximum of 102 ″ wide. To ensure the door frame opening 34 is approximately 100 ″ wide, the corner posts 32 should have a thickness T (FIG. 7B) of approximately 1 ″. However, the corner posts 32 must also maintain the structural strength necessary to support the horizontal head member 30 and resist the dynamic experienced during operation of the semi-trailer 14.

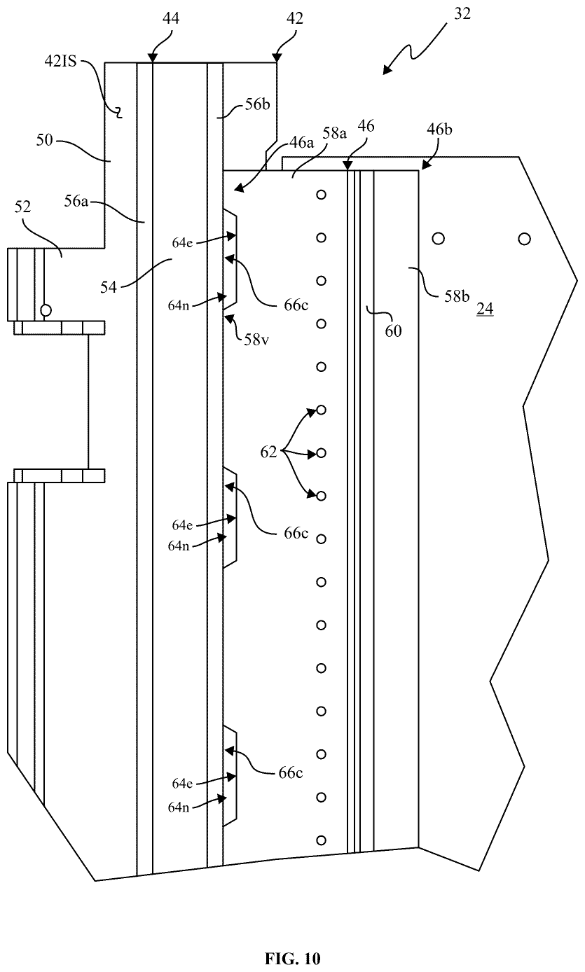

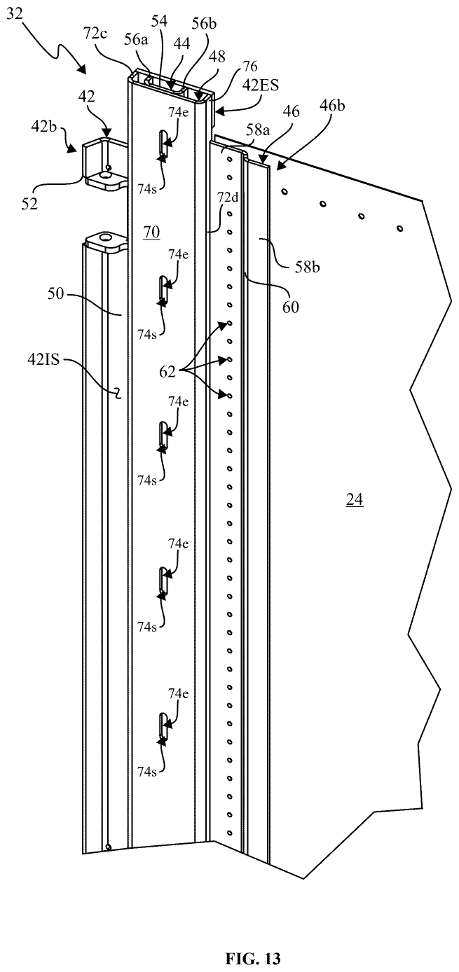

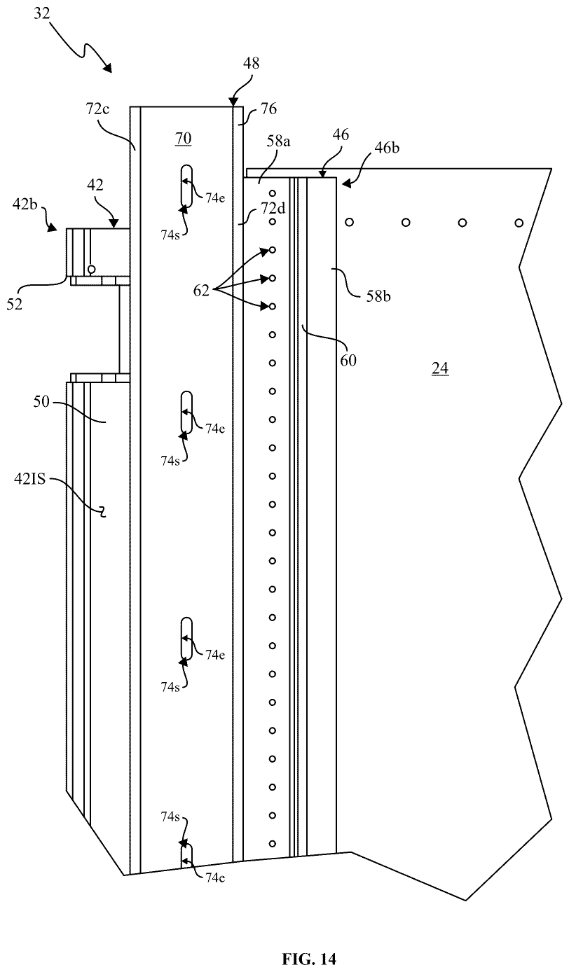

To minimize the thickness T of the corner posts 32 while maintaining the structural strength thereof, the corner posts 32 are constructed from a plurality of layered panels which are secured together to form a rectangular box-shaped structure. Specifically, as best seen in FIGS. 7B-14, the corner posts 32 are constructed from a plurality of panels including an exterior panel 42, a U-shaped intermediate panel 44, an S-shaped extension panel 46, and a U-shaped interior panel 48.

The exterior panel 42 forms the outermost portion of the corner post 32 and includes a planar section 50 and an angled section 52. The planar section 50 extends from a first end 42a of the exterior panel 42 towards a second end 42b of the exterior panel 42 and is defined between a planar interior surface 42IS and a planar exterior surface 42ES. The angled section 52 extends from the end of the planar section 50 to the exterior panel second end 42b and is adapted to engage hinge plates 36 (FIG. 7A-B) for coupling a door 12 to the corner post 32.

The U-shaped intermediate panel 44 is adapted to be secured to the exterior panel planar section 50 and includes a first planar middle section 54 and a pair of leg sections 56a, 56b extending one from each end of the first planar middle section 54. The first planar middle section 54 extends preferably parallel to the exterior panel interior surface 42IS. The leg sections 56a, 56b are preferably the same length and extend parallel to each other and perpendicularly from the first planar middle section 54. During assembly, the leg sections 56a, 56b are placed against/abutting secured the exterior panel interior surface 42IS and are secured thereto.

The S-shaped extension panel 46 is secured to the exterior panel interior surface 42IS adjacent to the U-shaped intermediate panel 44 and secures to the trailer side walls 24 by, for example, welding, brazing, adhering, or fastening. The S-shaped extension panel 46 includes a first end 46a, a second end 46b, a pair of planar end sections 58a, 58b, and an S-shaped middle section 60. The first planar end section 58a extends from the extension panel first end 46a towards the extension panel second end 46b and can include a plurality of bores 62. The bores 62 are adapted to receive fasteners (not shown) for securing the trailer side walls 24 to the S-shaped extension panels 46, and, hence, to the corner posts 32.

The second planar end section 58b extends from the extension panel second end 46b towards the extension panel first end 46a parallel to the first planar end section 58a. As best seen in FIG. 7B, the second planar end section 58b is preferably offset horizontally from the first planar end section 58a towards the interior of the trailer 14. The S-shaped middle section 60 extends between and connects the first and second planar end sections 58a, 58b. During assembly, the first planar end section 58a placed against/abutting the exterior panel inner surface 42IS adjacent to the U-shaped intermediate panel second leg section 56b.

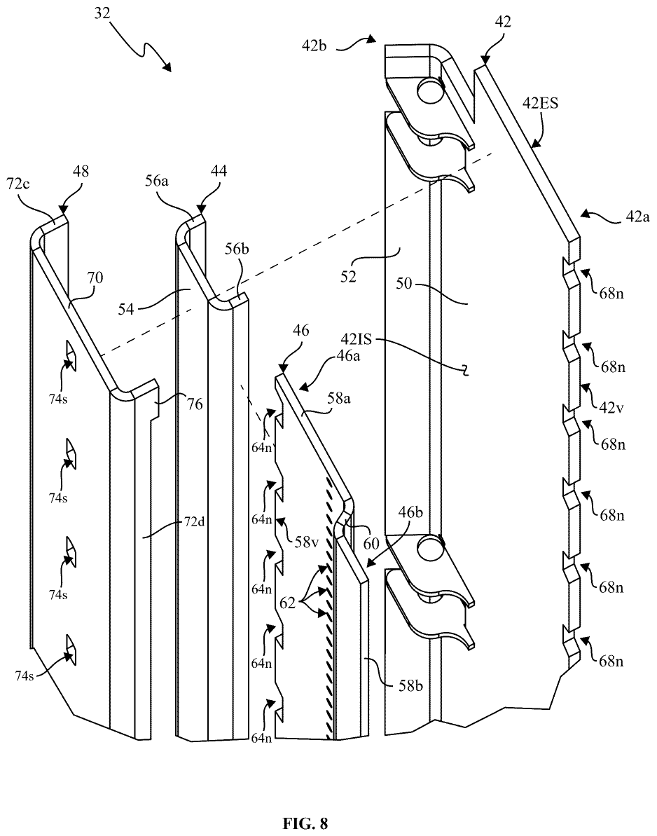

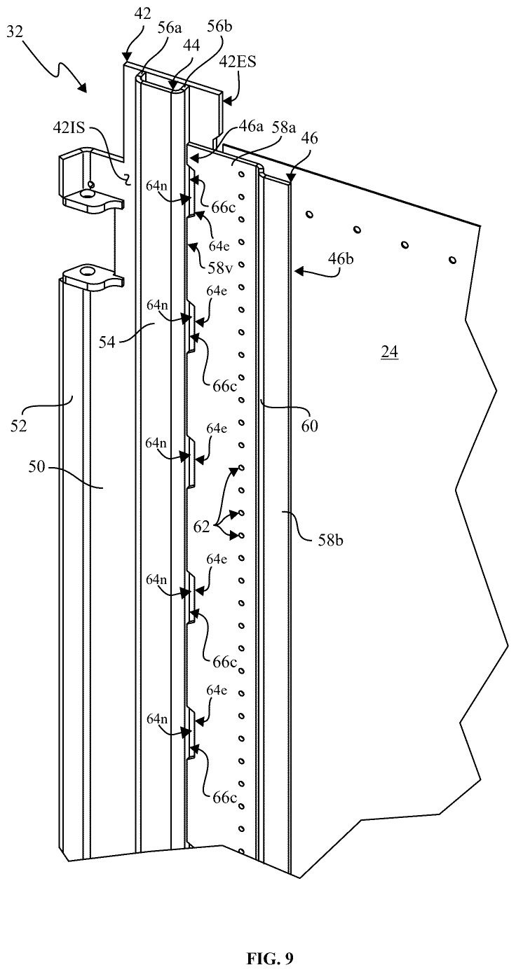

Preferably, the first planar end section 58a is secured to both the exterior panel inner surface 42IS and the second leg section 56b. Specifically, as best seen in FIGS. 8-10, the first planar end section 58a preferably includes a vertical edge 58v located at the extension panel first end 46a and a plurality of regularly spaced mounting notches 64n extending into the extension panel first end 46a along the vertical edge 58v. The mounting notches 64n can be trapezoid-shaped notches (as shown in FIGS. 8-10), or any other shape as may be necessary or desirable.

During assembly, the S-shaped extension panel 46 is positioned with the first planar end section 58a against/abutting the exterior panel interior surface 42IS and the vertical edge 58v against/abutting the second leg section 56b. The S-shaped extension panel 46 is then secured to the exterior panel 42 and the U-shaped intermediate panel leg section 56b by welding along the edges 64e of each mounting notch 64n and along corner edge 66c formed between the second leg section 56b and the exterior panel interior surface 42IS. Preferably, a filler material is used during the welding process whereby the notches 64n are substantially filled by the weld filler material (not shown).

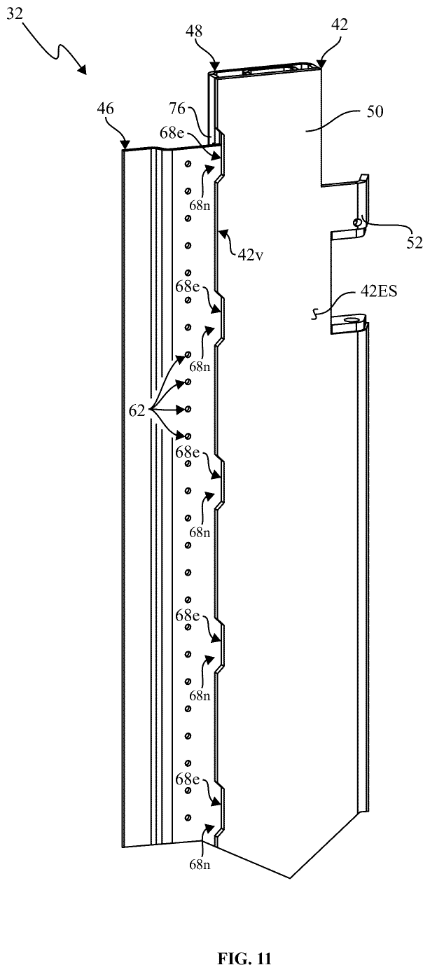

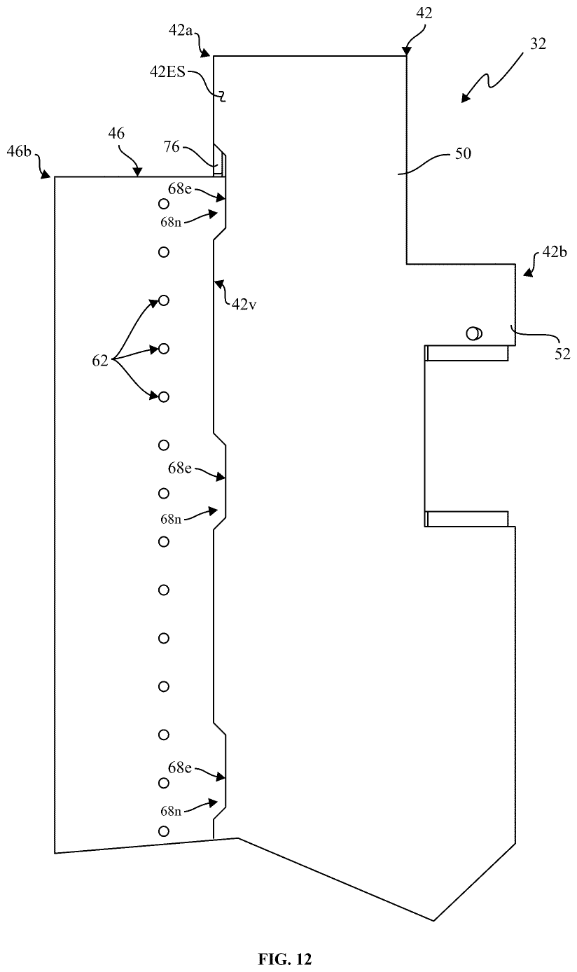

Yet more preferably, as best seen in FIGS. 11 and 12, the exterior panel 42 first end 42a includes a vertical edge 42v located at the exterior panel first end 42a and a plurality of regularly spaced mounting notches 68n extending into the exterior panel first end 42a along the vertical edge 42v. During assembly, the exterior panel 42 and the S-shaped extension panel 46 are further secured together by welding along the exterior panel vertical edge 42v and along the edges 68e of the exterior panel mounting notches 68n. Preferably, the exterior panel notches 68n are also filled by the weld filler material (not shown).

Returning to FIG. 7B, the U-shaped interior panel 48 is secured over top of the U-shaped intermediate panel 44 and forms the innermost portion of the corner posts 32. The total width of the door frame opening 34 (FIG. 6, dimension line DFW) is defined between the U-shaped interior panels 48 of the two vertical corner posts 32. The U-shaped interior panel 48 includes a second planar middle section 70 and a pair of leg sections 72c, 72d extending one from each end of the second planar middle section 70. During assembly, the second planar middle section 70 is placed against/abutting the first planar middle section 54 with the interior panel leg section 72c abutting the exterior panel interior surface 42IS and the interior panel leg section 72d abutting the first planar end section 58a. The interior panel leg sections 72c, 72d are then secured the exterior panel interior surface 42IS and the first planar end section 58a, respectively.

Preferably, the second planar middle section 70 includes a plurality of oval-shaped slots 74s. During assembly, the second planar middle section 70 is secured first planar middle section 54 by welding along the edges 74e of the oval-shaped slots 74s. Preferably, like the extension panel mounting notches 64n and the exterior panel mounting notches 68n, the oval-shaped slots 74s are also substantially filled by the weld filler material (not shown).

Preferably, as best seen in FIG. 8, interior panel leg section 72d includes an extended portion 76. The extended portion 76 extends vertically above the first planar end section 58a and abuts against the exterior panel interior surface 42IS. During assembly, the extended portion 76 can be welded to the exterior panel interior surface 42IS for securing the interior panel leg section 72d to both the first planar end section 58a and the exterior panel 42. Additionally, as best seen in FIGS. 11 and 12, the exterior panel notches 68n can be configured such that at least one exterior panel notch 68n is located adjacent to the extended portion 76. As such, when the exterior panel 42 is welded to the S-shaped extension panel 46 along the exterior panel vertical edge 42v and along the edges 68e of the exterior panel mounting notches 68n, the exterior panel 42 is also welded to the extended portion 76.

With respect to manufacturing and assembling the corner posts 32, each of the panels 42, 44, 46, 48 can be manufactured by, for example, extruding, bending, or otherwise molding or forming from a high-strength metal, such as, for example, steel or aluminum. Preferably, each of the panels 42, 44, 46, 48 can be manufactured by cutting sections from stock sheets of steel and bending the steel sheet sections into the desired shapes. The U-shaped intermediate panel 44 and the U-shaped interior panel 48 can also be manufactured by laser cutting sections from lengths of rectangular steel tubing stock. Preferably, the exterior panel mounting notches 68n, the extension panel mounting notches 64n, and the oval-shaped slots 74s can be formed in the panels 42, 46, 48 by, for example, laser cutting, plasma cutting, waterjet cutting, oxy-fuel gas cutting, or stamping or press cutting.

Once the panels 42, 44, 46, 48 have been manufactured, the corner posts 32 can then be assembled by, for example, positioning the U-shaped intermediate panel 44 adjacent to the exterior panel 42 with the intermediate panel leg sections 56a, 56b against/abutting the exterior panel interior surface 42IS. The U-shaped intermediate panel 44 is then temporarily secured to the exterior panel 42 by tack welding the intermediate panel leg sections 56a, 56b to the exterior panel interior surface 42IS. After the U-shaped intermediate panel 44 is temporarily secured to the exterior panel 42, the S-shaped extension panel 46 is positioned adjacent to the U-shaped intermediate panel 44 with the first planar end section 58a against/abutting the exterior panel interior surface 42IS and the extension panel vertical edge 58v against/abutting the intermediate panel leg section 56b. The S-shaped extension panel 46 is then temporarily secured to the exterior panel 42 by tack welding the first planar end section 58a to the exterior panel interior surface 42IS.

After the S-shaped extension panel 46 is temporarily secured to the exterior panel 42, if both the U-shaped intermediate panel 44 and the S-shaped extension panel 46 are located in the desired position, the U-shaped intermediate panel 44 is permanently secured to the exterior panel 42 by welding the intermediate panel leg section 56a to the exterior panel interior surface 42IS. The S-shaped extension panel 46 is then permanently secured to the exterior panel and the U-shaped intermediate panel 44 by welding the first planar end section 58a to the exterior panel interior surface 42IS and the intermediate panel leg section 56b along the extension panel vertical edge 58v, the corner edges 66c between the intermediate panel leg section 56b and the exterior panel interior surface 42IS, and the edges 64e of the extension panel mounting notches 64n.

After the U-shaped intermediate panel 44 and the S-shaped extension panel 46 are permanently secured to the exterior panel 42, the U-shaped interior panel 48 is positioned adjacent to the U-shaped intermediate panel 44 with the interior panel leg section 56a against/abutting the exterior panel interior surface 42IS, the second planar middle section 70 against/abutting the first planar middle section 54, and the interior panel leg section 56b against/abutting the first planar end section 58a. The U-shaped interior panel 48 is then permanently secured to the exterior panel 42, the U-shaped intermediate panel 44, and the S-shaped extension panel 46 by welding the interior panel leg section 56a to the exterior panel interior surface 42IS, welding the interior panel leg section 56b to the first planar end section 58a, and welding the second planar middle section 70 to the first planar middle section 54 along the edges 74e of the oval-shaped slots 74s. Additionally, the exterior panel 42 is permanently secured to the first planar end section 58a and the extended portion 76 by welding along the exterior panel vertical edge 42v and along the edges 68e of the exterior panel mounting notches 68n.

While this invention has been described as having an exemplary embodiment, the present invention may be further modified within the spirit and scope of this disclosure, such as, for example, by re-ordering the steps for manufacturing and assembling the corner posts 32. This application is therefore intended to cover any variations, uses, or adaptations of the invention using its general principles.

What is claimed is:

1. A method of manufacturing a corner post of a trailer door frame, the corner post comprising:
an exterior panel configured to couple a door to the door frame;
a U-shaped intermediate panel having a first planar middle section and first and second leg sections, the first and second leg sections extending from opposite ends of the first planar middle section;
an S-shaped panel having a first planar end section, a first S-shaped middle section, and a second planar end section, the first and second planar end sections extending from opposite ends of the first S-shaped middle section; and,
a U-shaped interior panel having a second planar mid-section and third and fourth leg sections, the third and fourth leg sections extending from opposite ends of the second planar mid-section;
the method comprising the steps of:
i. securing the first and second leg sections to the exterior panel;
ii. securing the first planar end section of the S-shaped panel to one of the first and second leg sections and/or to the exterior panel;
iii. securing the third leg section of the U-shaped interior panel to the exterior panel; and,
iv. securing the fourth leg section of the U-shaped interior panel to the first planar end section of the S-shaped panel and/or to the exterior panel.

2. The method of claim 1, wherein the panels are secured together by welding.

3. The method of claim 2, wherein the first planar end section of the S-shaped panel includes a first vertical edge having a first plurality of notches formed therein, wherein the first vertical edge is disposed adjacent to the second leg section of the first U-shaped panel, and wherein the first planar end section is welded to the second leg section and the outer panel interior surface along the first vertical edge.

4. The method of claim 2, wherein the exterior panel includes a second vertical edge having a second plurality of notches formed therein, wherein the second vertical edge is disposed adjacent to the first planar end section, and wherein the exterior panel is welded to the first planar end section along the second vertical edge.

5. The method of claim 2, wherein the second planar middle section of the U-shaped interior panel includes a plurality of slots formed therein, wherein the second planar middle section is disposed adjacent to the first planar middle section, and wherein the second planar middle section is welded to the first planar middle section along an edge of each slot.

6. The method of claim 2, wherein the exterior panel includes a second vertical edge having a second plurality of notches formed therein, wherein the second vertical edge is disposed adjacent to the first planar end section, and wherein the exterior panel is welded to the first planar end section along the second vertical edge.

7. The method of claim 6, wherein the second planar middle section of the U-shaped interior panel includes a plurality of slots formed therein, wherein the second planar middle section is disposed adjacent to the first planar middle section, and wherein the second planar middle section is welded to the first planar middle section along an edge of each slot.

8. The method of claim 7, wherein the first plurality of notches, the second plurality of notches, and the plurality of slots are substantially filled in with a weld filler material.

9. The method of claim 1 further comprising the step of manufacturing the exterior panel, U-shaped intermediate panel, S-shaped panel, and U-shaped interior panel by extruding, bending, stamping, or laser cutting from a stock material.

10. The method of claim 1 further comprising the steps of manufacturing the exterior panel and S-shaped panel by cutting and bending from stock sheets of steel and manufacturing the U-shaped intermediate panel and U-shaped interior panel by laser cutting sections from lengths of rectangular steel tubing stock.
